(19) United States
(12) Patent Application Publication
(10) Pub. No.: US 2023/0094716 A1
(43) Pub. Date: Mar. 30, 2023

(54) COUPLING SYSTEM FOR AN ELECTRIFIED VEHICLE

(71) Applicant: FORD GLOBAL TECHNOLOGIES, LLC, Dearborn, MI (US)

(72) Inventors: Thomas ZENNER, Dueren (DE); Thomas BIRKENBEIL, Hennef (DE)

(73) Assignee: FORD GLOBAL TECHNOLOGIES, LLC, Dearborn, MI (US)

(21) Appl. No.: 17/955,654

(22) Filed: Sep. 29, 2022

(30) Foreign Application Priority Data
Sep. 30, 2021 (DE) 102021125345.4

(51) Int. Cl. B60L 1/00; B60L 53/66; B60L 55/00; H02J 7/00; H02J 7/34

(52) U.S. Cl. CPC B60L 1/006; B60L 53/66; B60L 55/00; H02J 7/0063; H02J 7/345; H02J 7/00712; H02J 7/0068; B60L 2210/30; H02J 2207/20; H02J 2207/50

(57) ABSTRACT

A coupling system includes a vehicle cable having a plug configured to engage a vehicle charging port of a plug-in hybrid or battery electric vehicle, an electrical outlet configured to receive a plug of an AC powered appliance, a voltage converter, an energy store, and a controller configured to provide power from the vehicle charging port to the electrical outlet. The controller may provide a signal to the charging port of a connected electrified vehicle identifying the coupling system as a charging station to enable the electrified vehicle to provide power to the charging port. The controller may control the voltage converter to charge the energy store using power form a connected electrified vehicle. The controller may control the voltage converter and energy store to stabilize power from the vehicle provided to the electrical outlet.

### CROSS-REFERENCE TO RELATED APPLICATIONS

This application claims foreign priority benefits under 35 U.S.C. § 119(a)-(d) to DE 10 2021 125 345.4 filed Sep. 30, 2021, which is hereby incorporated by reference in its entirety.

### TECHNICAL FIELD

The disclosure relates to a coupling system for an electrified vehicle.

### BACKGROUND

As an alternative or complement to motor vehicles with an internal combustion engine, electrified vehicles are gaining in significance. In addition to vehicles which draw their energy from fuel cells, primarily electric vehicles having a rechargeable battery (or normally a plurality of rechargeable batteries or battery packs) are widespread. These electrified vehicles may include plug-in hybrid electric vehicles (PHEVs) as well as battery electric vehicles (BEVs). For charging, the electric vehicle is connected to a charge source via a cable, wherein different charging modes using correspondingly different cables are possible. Four different charging modes have been defined in the international standard IEC 61851 which are often referred to as Mode 1 to Mode 4. In Mode 1, the cable is used exclusively for energy transmission (and normally for grounding). In Mode 2, the cable has a device which provides control and protection functions for the charging. In Mode 3, the control and protection function is incorporated in a fixedly installed charger. While Mode 1 to Mode 3 are intended for AC charging, Mode 4 is intended for DC charging methods in which two-sided communication between the vehicle and the charge source takes place.

A so-called smart grid may use the internal energy store of electric vehicles to mitigate load peaks within the grid. That is to say it should be possible, if necessary, to reverse the charging process, wherein energy is fed from the electric vehicle into the grid. This function is also referred to as “vehicle to grid (V2G)”. Depending on the number of connected electric vehicles, considerable power can be provided for the grid. For this purpose, the electric vehicle and the charging station need to be configured for bidirectional energy transfer. The communication between the vehicle and the charging station for this capability is defined in the standard ISO 15118-20. The bidirectional energy flow is possible either via alternating current (AC) and may be referred to as “on-board V2G”, or via direct current (DC) and may be referred to as “off-board V2G”, depending on whether the DC/AC conversion takes place in the vehicle or in the charging infrastructure. Both concepts have associated advantages and disadvantages. In the case of on-board V2G, a charging system in the vehicle needs to be designed to convert AC voltage from the grid into DC voltage for the vehicle battery during normal charging, and DC voltage from the vehicle battery into AC voltage during “reverse” charging, i.e. when there is a feed of energy into the grid. Since the grid can be regarded as a load of infinite size, the charging system is designed to produce a defined AC current of constant amplitude. Depending on various factors, such as, for example, state of charge (SOC) of the battery, the electric vehicle can feed back into the grid with a different power.

Some electric vehicles also support a “power to the box (PTTB)” function (also referred to as “vehicle to load” function (V2L)), in which the energy of the vehicle battery can be used to supply power to appliances operated on line voltage (for example electric tools). The power drawn from the electric vehicle is made available at a socket outlet which can be located in the cab of the vehicle and/or on an outer side of the vehicle. That is to say that a line voltage which is as stable as possible (for example of 110V or 230V) is generated, wherein sometimes considerable power outputs of over 6 kW are possible. For this purpose, a dedicated inverter may be provided, which generates the corresponding AC voltage and also stabilizes it to respond to possible changes in the power draw. The user therefore has the possibility of using appliances configured for operation on the grid independently of the grid, to a certain extent in this so-called island operating mode. This is at present only possible, however, with electric vehicles which are correspondingly equipped, wherein the additional inverter complicates the design of the vehicle, increases its weight or mass, and requires additional installation space.

### SUMMARY

Various embodiments according to the disclosure may provide a coupling system to facilitate an island operating mode for an electric vehicle to power one or more electric appliances.

Reference is made to the fact that the features and measures listed individually in the description below can be combined with one another in any desired technically sensible way and reveal further configurations of the claimed subject matter. The description characterizes and specifies representative non-limiting embodiments of the claimed subject matter in connection with the figures.

In various embodiments, a coupling system is configured to be connected to the electric vehicle or to connect an appliance to the electric vehicle. As will become clear from the text below, the coupling system is used for supplying energy to at least one appliance, which is configured for operation on a household grid, independently of the household grid. The coupling system and the electric vehicle can also be considered as being parts of an energy supply system that is independent of the grid. To this extent, the coupling system cooperates with the vehicle to provide an energy supply unit.

In one or more embodiments, the coupling system is portable, i.e. transportable by hand. The coupling system is configured to connect an appliance designed for connection to a household grid or mains to an electric vehicle. The household grid to which reference is made herein is generally a low-voltage grid, for example the 230 VAC or 110 VAC voltage grid, sometimes also a three-phase grid. The coupling system includes an appliance socket compatible with the appliance cord and similar to sockets or outlets of the household grid. The appliance socket can also be referred to as a socket outlet or outlet in some embodiments. It is provided as the female part of a plug-type connector coupling in which the male part is formed by a (power) plug of the appliance. It can be installed fixedly on a housing of the coupling system and can correspond to a household socket outlet (for example a Schuko socket outlet) with respect to the physical configuration and the number and connection of the contacts provided. Alternatively, however, it could also be arranged at the end of a flexible cable. In any case, the appliance socket corresponds in terms of its configuration to the sockets of a household grid, with the result that a plug of an appliance which is operable on the corresponding household grid can also be coupled to the appliance socket. For example, the appliance socket can be designed to receive a Europlug, a Schuko plug or the like.

The coupling system includes a vehicle plug, which can be coupled to a charging port of an electric vehicle. Here and in the text which follows, the term “couple” is used to have an equivalent meaning to “connect”, in particular “detachably connect”. The electric vehicle is normally a road vehicle, for example a passenger car, truck, RV, bus, commercial vehicle or a heavy goods vehicle, or an electric two-wheeled vehicle. In this sense the term “electric vehicle” refers both to purely electric vehicles and to plug-in hybrid vehicles. In any case, the electrified vehicle has an electric machine that can be powered via at least one vehicle-internal or on-board battery. The charging port of the electric vehicle is used during a normal charging process for transmitting energy from a charge source or a charging station via a charging cable to the electric vehicle. That is to say that the electric vehicle or a battery thereof can be charged via the charging port. In the case of such a charging process, the charging cable, which can either be fixedly connected to the charging station or else can be a separate component part which is disconnectable from the charging station or the charge source, is connected to the charging port by a corresponding plug. In many cases, the vehicle plug represents the female part of the connection and, strictly speaking, should be referred to as the “socket”, while the charging port represents the male part and would therefore also be referred to as a “plug”. Colloquially, these designations are often used incorrectly. In any case, the term “vehicle plug” should not be interpreted as meaning that it must be the male part of the connection.

The vehicle plug can be coupled to the charging port and to this extent is compatible with the charging port. As will be explained below, this is not used for the transmission of energy to the electric vehicle, however, but for the withdrawal of energy from the electric vehicle. For reasons of ease of use, the vehicle plug is normally arranged on a flexible cable, which enables largely independent positioning of the vehicle plug and the appliance socket relative to one another. It goes without saying that the power plug has a plurality of electrical contacts which are electrically connected to associated conductors within the coupling system, for example, if provided, within the cable. In particular, in order to perform the energy withdrawal, at least two active conductors (for example an line conductor and a neutral conductor) are necessary and, additionally an earth or grounding conductor may be provided. In the case of a flow of energy from the vehicle to the consumer, in a single-phase IT (isolé-terre) system there is no neutral conductor, rather only two line conductors. An IT system is an electrical distribution system that has no connection to earth, only a high-impedance connection. The individual conductors are of course electrically insulated from one another and normally are totally surrounded by an additional insulation which enables electrical and mechanical protection while at the same time providing flexibility of routing of the cable. In particular, the charging port can be configured, for example, in accordance with the standard EN 62196 for Type 2 plugs. The vehicle plug is then a corresponding Type 2 plug. In particular, the charging port and the electric vehicle can be configured overall for Mode 3 corresponding to the international standard IEC 61851. As an alternative, the vehicle plug could also be, for example, a Type 1 plug, however.

Furthermore, the coupling system has a controller, which is designed to signal to the electric vehicle to provide an AC vehicle current at the charging port when the vehicle plug is coupled, wherein the coupling system is designed to provide an AC appliance voltage, which corresponds to the household grid, at the appliance socket with the aid of the AC vehicle voltage. The controller can physically consist of one or more components which can also be spaced apart from one another and can be connected by corresponding lines. The controller or some of its functions can also be implemented at least partially using software. Normally, the controller is overall arranged in a housing on which the abovementioned appliance socket can also be arranged. Under certain circumstances, it would also be conceivable for the controller to be arranged together with the vehicle plug in a common housing, while the appliance socket is connected to this housing by a flexible cable.

When the vehicle plug is coupled to the charging port of the electric vehicle, the controller is designed to communicate to the electric vehicle to transfer power back to the grid. Although a wireless signal transmission is not fully ruled out, it is generally provided that the signal transmission takes place via the vehicle plug and the charging port. Correspondingly, the controller is electrically connected to the vehicle plug possibly via the abovementioned cable. On the side of the electric vehicle, a charging controller is normally for its part connected to the charging port and can therefore receive a wired signal via the charging port. The charging controller is in this case firstly designed to control or to monitor ordinary charging of the electric vehicle. Secondly, it is also designed to control discharge of the electric vehicle, wherein the abovementioned AC vehicle voltage is provided at the charging port. The AC vehicle power is generated via a converter which is arranged within the electric vehicle and which for its part receives a DC power from at least one vehicle battery and converts it in order to generate the AC vehicle power.

Furthermore, the coupling system is designed to provide an AC appliance voltage, which corresponds to the household grid, at the appliance socket. More precisely, the coupling system uses the AC vehicle power at least temporarily, normally at least predominantly, to provide the AC appliance power. Although a distinction is drawn here in terms of terminology between the AC vehicle voltage and the AC appliance voltage, depending on the configuration it is possible for the AC vehicle voltage and the AC appliance voltage to be identical in terms of frequency, amplitude and waveform or to only have insubstantial differences. In general, when, for example, there is no direct connection between the vehicle plug and the appliance socket, various modifications are also possible, however, wherein in particular the amplitude of the AC appliance voltage could differ from that of the AC vehicle voltage. Within the scope of the claimed subject matter, it would be possible, although unusual, for the frequency of the AC vehicle voltage and of the AC appliance voltage to be different. In any case, the AC appliance voltage corresponds to the household grid, i.e. the frequency of the AC appliance voltage is identical to that of the household grid (for example 50 Hz or 60 Hz) or differs only so slightly that the difference is negligible for the practical application. The amplitude of the AC appliance voltage also lies at least temporarily or predominantly in a range which is considered normal for the household grid (for example 230 V±23 V rms value, or 110 V±11 V rms value). Correspondingly, an appliance which can be operated on the household grid can also be operated independently of the grid via the coupling system on the electric vehicle when it is connected to the appliance socket. It goes without saying that when an appliance is connected to the appliance socket, the coupling system is designed to withdraw energy or power (with the AC vehicle voltage) from the vehicle via the vehicle plug and the charging port and output energy or power (with the AC appliance voltage) via the appliance socket.

The energy supply system according to one or more embodiments of the disclosure enables an operation, independently of the grid, of various appliances which are configured for connection to a household grid. In this case, effectively a “power to the box (PTTB)” function is made available even when the electric vehicle is not configured for this per se. The decisive mediation function is taken on by the coupling system, which firstly makes available the appliance socket which physically enables the connection of the abovementioned appliance and secondly is configured to transmit a suitable signal to the electric vehicle which instructs the electric vehicle to provide the AC vehicle power, which is then ultimately used for the provision of the AC appliance power and for supplying energy to the appliance. Therefore, the energy supply system is ideally suited for retrofitting in order to nevertheless enable a PTTB function in the case of various electric vehicles which, per se, do not provide such a function. In other words, appliances configured for operation on the grid can be operated in the island operating mode, independently of the household grid, with the energy supply system according to the disclosure. The only prerequisite in this case on the part of the electric vehicle is that it is designed to provide the AC vehicle power at the charging port on reception of a corresponding signal. A corresponding functionality of the electric vehicle is generally provided at least in the case of those electric vehicles which are configured for use in a smart grid in which they temporarily output energy to a charging station in order to manage or mitigate load peaks within the grid. To this extent, the complexity involved in the retrofitting is restricted to the purchase of the coupling system. The coupling system can be embodied to be comparatively light and space-saving so that it can easily be carried by a single person and can also be carried along, for example, in the trunk of the electric vehicle for use when required without significantly affecting vehicle mileage or efficiency.

Optionally, the controller can provide protection functions, in particular residual current protection and/or overcurrent protection. These functions can alternatively also be performed by other units.

In one or more embodiments, the controller is designed to transmit a communication signal to the electrical vehicle via the vehicle plug from which the electric vehicle identifies a connection to a charging station. The communication signal can be assigned to a high-level communication, which takes place, for example, in accordance with the standard ISO 15118-20. It is also possible that the communication signal is transmitted via the same conductor as a control pilot signal. The control pilot signal or CP signal is generally used for a communication with the electric vehicle. In this case, generally a modulated (in particular pulse-width-modulated) signal is transmitted, wherein this can be referred to as a low-level communication. In the case of a connection to a charging station, the electric vehicle can, for example, derive the maximum possible current of the charge source from the control pilot signal. The corresponding signal can be received by the electric vehicle and the charging process can be controlled correspondingly. Conversely, in the case of a smart network, the charging station can communicate to the electric vehicle by means of a (high-level) communication signal that the charging process is intended to be temporarily reversed, i.e. that energy is intended to be fed into the grid from the vehicle battery. Within the scope of the claimed subject matter, different configurations are conceivable. For example, the electric vehicle can be configured to identify from a first signal the connection to the charge source and from a following second signal the request to provide the AC vehicle power at the charging port for feeding into the network. It would also be conceivable that the electric vehicle identifies from a single signal that it is connected to a charging station and that this charging station is requesting an energy feed into the network. In any case, in this embodiment the controller is designed to simulate the connection to a charging station via the corresponding communication signal. That is to say that the electric vehicle, for example an abovementioned charging controller thereof, assumes on reception of the communication signal that it is connected to a charging station although the signal in this case originates from the controller of the coupling system. Therefore, in this case the compatibility of the electric vehicle with a smart grid is used in order to implement the PTTB function.

As already mentioned, the vehicle plug has a plurality of electrical contacts. Normally, in each case one contact is assigned to a proximity pilot signal conductor, a control pilot signal conductor, active conductors and a PE (protective earth or ground) conductor. The respective active conductor is a conductor which carries current during the charging process. The control pilot signal conductor is used for transmitting the control pilot signal (low level) and optionally for transmitting the abovementioned communication signal (high level). The proximity pilot signal conductor is used for transmitting a proximity pilot signal. By means of the proximity pilot signal or PP signal, which can also be referred to as presence signal or proximity signal, the electric vehicle can firstly establish the connection to the coupling system (or a charging station) per se, and secondly normally additional information on the characteristics of the coupling system or the charging station and/or of a charging cable used can be derived from the proximity pilot signal, for example the maximum permissible ampacity.

For reliable operation, it is desirable for the coupling system to have an energy store which is independent of the electric vehicle and is at least connectable via a converter unit to the vehicle plug and to the appliance socket. The energy store is normally at least one rechargeable battery, which can be integrated, for example, in the abovementioned housing of the coupling system. At least one capacitor having a sufficiently high capacitance could also be used. The energy store is at least connectable to the appliance socket and to the vehicle plug, i.e. either permanently connected or optionally connectable or disconnectable via at least one switch unit. The permanent or temporary connection is provided via a converter. This converter is designed to convert a DC voltage present at the energy store into an AC voltage, or vice versa. In particular, it is possible that the energy store is designed to supply power to the controller. By means of this supply of energy, it is ensured, for example, that the controller can transmit the abovementioned communication signal to the electric vehicle without energy needing to be drawn from the electric vehicle for this purpose. In particular, the energy store can act as a buffer store, as will be explained further below.

As has already been explained above, the coupling system can simulate a connection of the electric vehicle to a charging station. In the case of such a connection, the charging station on the grid side would make available a (line) voltage which is detected by the electric vehicle, and to which said electric vehicle synchronizes itself. That is to say that the electric vehicle expects, independently of the control pilot signal, such a line voltage in order to be able to initiate the energy feed into the grid. Correspondingly, the controller is preferably designed to generate, when the vehicle plug is connected to the charging port, an AC connection voltage in the vehicle plug by means of the energy store and the converter unit, which AC connection voltage can be detected by the electric vehicle. The controller can be designed to establish that the vehicle plug has been connected to the charging port, and thereupon to generate the AC connection voltage. In this case, a DC voltage withdrawn from the energy store is inverted by means of the converter unit, and the AC connection voltage thus generated is made available at the vehicle plug (between contacts which are assigned to active conductors). Although a distinction is drawn here in terms of terminology between the AC appliance voltage and the AC connection voltage, both AC voltages are normally applied between the same conductors.

The controller may be configured to monitor the AC appliance voltage and to stabilize it within a setpoint value range. The aim here is of course to keep the AC appliance voltage at least predominantly in a range which corresponds to the tolerance range which also applies for the corresponding household grid (for example 230 V±23 V, or 110 V±11 V). For this purpose, the controller can, for example, tap off the AC appliance voltage between the abovementioned active conductors and continuously or repeatedly measure it. When the setpoint value range is left, the control unit or controller introduces corresponding countermeasures. One advantage with this configuration consists in that the stabilization of the AC appliance voltage is not dependent on a corresponding monitoring and stabilization by the electric vehicle, i.e. the corresponding closed-loop control function with the underlying logic can be implemented completely within the controller of the coupling system. As a result, the coupling system can be used with different electric vehicles, namely even with those which, on their own, do not have any corresponding closed-loop control function, i.e. cannot provide a self-sustained V2L function.

In accordance with one embodiment, the controller can be designed to signal to the electric vehicle to change an alternating current flowing through the charging port in the event of a lack or excess of AC vehicle power. The corresponding signaling can in turn take place via the abovementioned (digital) communication signal, for example in accordance with ISO 15118-20. The controller in this case transmits a signal to the electric vehicle (normally to the charging controller or controller), with the result that said electric vehicle changes the alternating current through the charging port. If the AC appliance voltage falls below the setpoint value range, for example in the case of a particularly high power withdrawal by a consumer connected to the appliance socket, the controller can request an increase in the alternating current; if the AC appliance voltage exceeds the setpoint value range, the controller can request a reduction in the alternating current. The corresponding request can take place via the mentioned communication signal. In this case, different adaptation strategies are possible. For example, the controller could at least approximately determine, on the basis of the deviation of the AC appliance voltage, the value by which the alternating current needs to be changed in order that the AC appliance voltage returns to the setpoint value range again or a stepwise adaptation could be performed, wherein only the tendency of the necessary adaptation is determined but this is performed in steps of always the same size. After each adaptation step, a comparison can again be performed to ascertain whether the setpoint value range has been reached again. The controller and the electric vehicle in this case form parts of a first control loop.

Within the first control loop, the responses of the electric vehicle nevertheless take place generally comparatively slowly. In addition, under certain circumstances only an adaptation of the first alternating current within discrete steps is possible, with the result that the adaptation of the AC appliance voltage in this way can in principle only take place roughly. It is therefore preferred, normally in addition to the abovementioned configuration, that the controller is designed to stabilize the AC appliance voltage by charging/discharging the energy store. The controller and the energy store in this case form parts of a second control loop, which generally responds more quickly and more precisely than the first control loop. Nevertheless, the charging/discharging capacity of the energy store—as part of a normally portable coupling system—is generally substantially lower than that of the vehicle battery, with the result that the second control loop is normally used as an addition to the first control loop. Normally, a direct current made available by the energy store is converted by the converter into an alternating current which is added to the alternating current withdrawn from the charging port in the line conductor and thus enables, if required, a higher power withdrawal at the appliance socket without this resulting in a relatively long, noticeable voltage drop. It would even be conceivable to compensate for an at least short-term complete stoppage of the alternating current from the charging port in this way.

In general, a certain minimum charging of the energy store is necessary to ensure that the controller remains operationally ready even when disconnected from the electric vehicle and that the abovementioned AC connection voltage can be provided. For this reason, the controller is designed to monitor a state of charge of the energy store and to prevent a withdrawal of energy from the energy store when the state of charge falls below a preset minimum value.

The abovementioned stabilization of the AC appliance voltage by virtue of charging/discharging the energy store is intended to ideally compensate for short-term fluctuations, whereas the state of charge of the energy store is overall ideally not intended to be substantially reduced during the operation of an appliance at the appliance socket. That is to say that the temporary discharge needs to be compensated for in this case. For this purpose, the controller can be designed to charge the energy store by withdrawing energy from the electric vehicle. In this case, an alternating current is withdrawn via the charging port, the vehicle plug and the active conductors, said alternating current being converted into direct current at least partially via the converter and being fed into the energy store. The charging of the energy store can firstly take place when the power output by the electric vehicle is greater than the power withdrawn by the consumer at the appliance socket. Secondly, independently of this, charging can take place even when a minimum charge of the energy store is undershot, wherein a disconnection of the consumer is accepted.

### BRIEF DESCRIPTION OF THE DRAWINGS

FIG. 1 shows a schematic illustration of an electric vehicle connected to a charging station in accordance with the prior art.

FIG. 2 shows a schematic illustration of an electric vehicle, a coupling system according to the disclosure, and a connected appliance.

### DETAILED DESCRIPTION

As required, detailed embodiments of the claimed subject matter are disclosed herein; however, it is to be understood that the disclosed embodiments are merely representative and the claimed subject matter may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

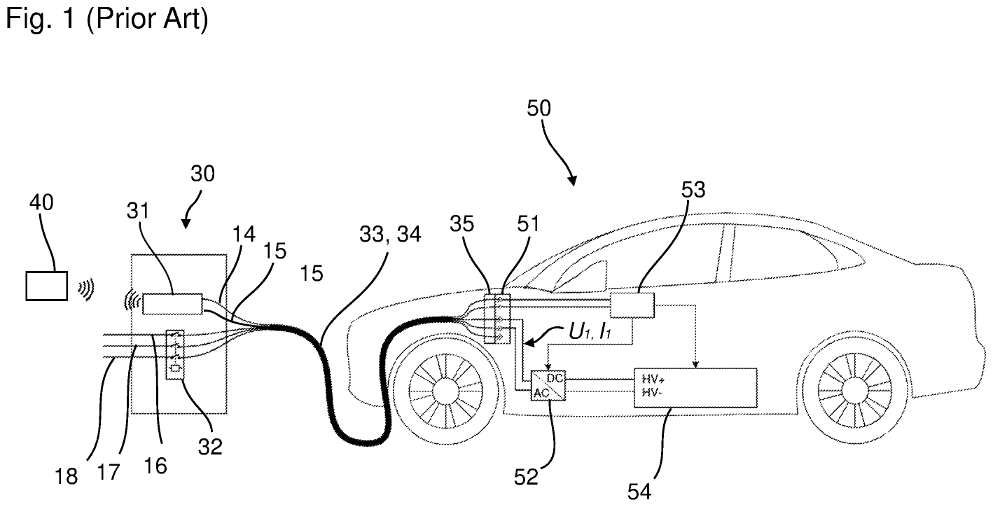

FIG. 1 is a schematic illustration of an electric vehicle 50, in this case a passenger vehicle, which is connected to a charging station 30 of a smart grid. A charging cable 33 which is fixedly connected to the charging station 30 includes a flexible line 34 and a vehicle plug 35, which is coupled to a charging port 51 of the electric vehicle 50. The charging station 40 is in this case configured for a Mode 3 charging process, and the vehicle plug 35 is a Type 1, wherein the functional principle can of course also be transferred to a Type 2 plug. In total, five conductors 14-18 are provided within the charging cable 33 and lead to corresponding contacts in the vehicle plug 35, namely a proximity pilot signal conductor 14, a control pilot signal conductor 15, two active conductors 16, 17 and a PE (also referred to as a ground) conductor 18.

The active conductors 16, 17 and the PE conductor 18 are routed substantially through the charging station 30, wherein they nevertheless can be interrupted by contactors within a switch 32. The switch 32 is driven by a controller 31 (which generally has one or more integrated circuits). Furthermore, the controller 31 is nevertheless also connected to the proximity pilot signal conductor 14 and the control pilot signal conductor 15. Via the control pilot signal conductor 15, the controller 31 provides a control pilot signal (CP signal) for the electric vehicle 50 and a digital communication signal in accordance with the standard ISO15118-20. For example, the controller 31 can query the present state of the electric vehicle 50 via the control pilot signal conductor 15, for example whether the electric vehicle is ready for charging, is already fully charged or the like. At the same time, the controller 31 makes available, via the proximity pilot signal conductor 14, a proximity pilot signal (PP signal). On the side of the electric vehicle 50, the proximity pilot signal conductor 14 and the control pilot signal conductor 15 are connected to a charging controller 53, which queries the proximity pilot signal and receives the control pilot signal and the high-level communication signal. The charging controller 53 in addition drives a converter 52 (which, inter alia, transforms and rectifies the alternating current transmitted via the charging cable 33) and a vehicle battery 54 of the electric vehicle 50.

The controller 31 can, as part of the smart grid, control both charging of the electric vehicle and interim discharge, i.e. a return feed of energy into the grid. By virtue of the latter, load peaks within the grid can be mitigated or managed. Whether this is necessary is not decided by the controller 31 itself but rather it receives corresponding control signals from a master charging controller 40, which is illustrated purely schematically here and is generally far removed from the charging station 30. The communication between the master charging controller 40 and the charging station 30 can take place wirelessly, as indicated here, but it would of course also be possible for there to be a wired communication. If the master charging controller 40 requests interim discharge of the electric vehicle 50, the controller 31 of the charging station 30 signals this to the electric vehicle 50 by means of the digital communication signal. Thereupon, the converter 52 (bi-directional onboard charger) synchronizes to the voltage U and provides power to the grid (if further conditions allow for this).

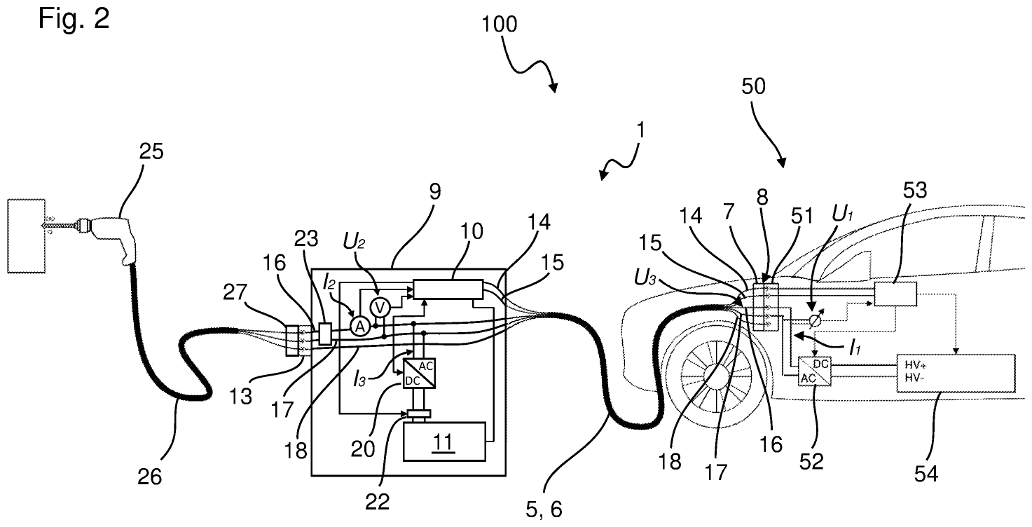

FIG. 2 again shows the electric vehicle 50 from FIG. 1, which nevertheless in this case is not connected to a charging station 30. Instead, a coupling system 1 according to the disclosure is connected to the charging port 51 via a vehicle plug 7. The vehicle plug 7 is connected to a housing 9 of the coupling system 1 via a flexible line 6 of a connecting cable 5. In turn, the proximity pilot signal conductor 14, the control pilot signal conductor 15, the active conductors 16, 17 and the PE conductor 18 are arranged within the connecting cable 5. A controller 10, which is connected to the proximity pilot signal conductor 14 and the control pilot signal conductor 15, is arranged within the housing 9. In this case, said controller can communicate with the charging controller 53 via the control pilot signal conductor 15, wherein, firstly, a control pilot signal (low level) is transmitted and secondly a digital communication signal, for example in accordance with the standard ISO 15118-20. The active conductors 16, 17 and the PE conductor 18 are routed through the housing 9 to an appliance socket 13 on the outside. The appliance socket 13 corresponds in terms of design and configuration to a socket outlet of a household grid, for example a Schuko socket outlet of a 230 V grid. The active conductors 16, 17 can be interrupted via a protective device 23 e.g. if an overcurrent or a residual current is established.

In order to ensure an operation of the coupling system 1 and in particular of the controller 10 which is independent of the electric vehicle 50 (as well as grid-independent), a rechargeable battery 11 acting as an energy store is provided within the housing 9. This rechargeable battery is connected to the active conductors 16, 17 via a bi-directional AC/DC converter 20, wherein the connection can be interrupted by a switch 22 in the event of an emergency. The bi-directional AC/DC converter 20 is controlled by the controller 10, as is the switch 22.

While controller 10 is illustrated as a single controller, controller 10 generally represents one or more controllers or control modules that may include integrated circuits and/or logic, micro-controllers, and programmable microprocessor-based controllers that perform various functions and algorithms based on stored program instructions that may be stored in a non-transitory storage medium accessible by the controller.

An appliance 25, in this case a rotary hammer drill, which is intended for connection to the household grid is coupled to the appliance socket 13 via a power cable 26 and a power plug 27. The power plug 27 in this case is a standardized Schuko plug. To enable operation of the appliance 25 on an appropriate AC appliance voltage U₂, energy is withdrawn from the vehicle battery 54, with the result that the coupling system 1 and the electric vehicle 50 together form an energy supply system 100 for the appliance 25. The controller 10 communicates with the charging controller 53 via the control pilot signal line 15, the vehicle plug 7 and the charging port 51, to be precise by means of the digital communication signal. This communication signal is not to be distinguished by the charging controller 53 from a signal which it would receive when the electric vehicle 50 is connected to a charging station 30, which requests a temporary discharge, i.e. a feed of energy into the grid. To this extent, the charging controller 53 does not need to be specially adapted to the coupling system 1 or tuned thereto. In addition, the controller commands to generate, at the vehicle plug 7, more precisely between the active conductors 16, 17, an AC connection voltage U₃ whose characteristic corresponds to the household grid. In order to generate the AC connection voltage U₃, the controller 10 drives the bi-directional AC/DC converter 20 to invert a voltage present at the battery 11 and apply it between the active conductors 16, 17. The converter 52 detects the AC connection voltage U₃ and synchronizes to it.

By virtue of the provided AC power of the converters 20 and 52 the appliance 25 can be operated. The controller 10 in this case monitors the AC appliance voltage U₂ and a second alternating current I₂ flowing via the line conductor 16 to the appliance socket 13. The latter can be at least temporarily identical to the first alternating current I₁. The controller 10 in this case attempts to keep the AC appliance voltage U₂ within a setpoint value range (for example 230 V±23 V rms value). In the case of interim load peaks of the appliance 25, the AC appliance voltage U₂ can under certain circumstances fall below the setpoint value range. This can be counteracted by the controller 10 in two ways, wherein the procedures described below are normally used in combination. Firstly, the controller 10 can request an increase in the first alternating current I₁ via the digital communication signal. In this case, the controller 10, the charging controller 53 and the vehicle battery 54 form parts of a first control loop, which, however, responds comparatively slowly and imprecisely and therefore on its own normally only roughly stabilizes the AC appliance voltage U₂. Secondly, energy can be withdrawn from the battery 11 via the bi-directional AC/DC converter 20 and fed into the line conductor 16 in the form of a third alternating current I₃. In this case, the controller 10, the bi-directional AC/DC converter 20 and the battery 11 form parts of a second control loop, which responds much more quickly and precisely than the first control loop. When the power withdrawal by the appliance 25 decreases again, the battery 11 can be charged by means of rectified AC voltage, which is tapped off between the active conductors 16, 17. For this the bi-directional AC/DC converter is operated in reverse to feed energy back into the battery 11.

The controller 10 monitors a state of charge of the battery 11 and checks whether this state of charge falls below a preset minimum value. If it does, no more energy is withdrawn from the battery 11 even if this means an impairment or even a deactivation of the appliance 25. By maintaining the minimum value it is ensured that the controller 10 remains functional and that the AC connection voltage U₃ can be generated when the vehicle plug 7 is (newly) connected to a charging port 51

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly described or illustrated.

What is claimed is:

1. A coupling system for an electrified vehicle having a traction battery configured to power an electric machine, the system comprising:
an electrical socket configured to receive an appliance plug configured to connect an appliance to a household electrical outlet;
a vehicle cable having a vehicle plug configured to connect to an external charging port of the electrified vehicle;
a voltage converter; and
a controller configured to generate a signal on the vehicle cable that causes the electrified vehicle to provide an AC vehicle power at the charging port in response to connecting the vehicle plug to the charging port, wherein the voltage converter is powered by the traction battery and converts vehicle voltage to an AC appliance voltage corresponding to household electrical outlet voltage at the electrical socket.

2. The coupling system of claim 1 wherein the controller is configured to transmit a communication signal to the electric vehicle via the vehicle plug that identifies the coupling system as a vehicle charging station.

3. The coupling system of claim 1 wherein the vehicle plug comprises a plurality of electrical conductors including a proximity pilot signal conductor, a control pilot signal conductor, at least two active conductors, and a ground conductor.

4. The coupling system of claim 1 further comprising an energy store electrically connected to the voltage converter.

5. The coupling system of claim 4 wherein the energy store comprises a rechargeable battery.

6. The coupling system of claim 4 wherein the energy store comprises at least one capacitor.

7. The coupling system of claim 4 wherein the voltage converter comprises a bi-directional AC/DC converter to transfer power between the energy store and the AC line

8. The coupling system of claim 4 wherein the controller is configured to generate an AC connection voltage in the vehicle plug powered by the energy store via the voltage converter in response to connection of the vehicle plug to the charging port.

9. The coupling system of claim 4 wherein the controller controls the voltage converter to supply power from the energy store to the electrical socket in response to the AC appliance voltage being outside a predetermined range of a nominal AC appliance voltage.

10. The coupling system of claim 4 wherein the controller is configured to charge the energy store using power supplied via the vehicle cable.

11. The coupling system of claim 1 wherein the controller is configured to provide a signal to the vehicle cable requesting modification of AC power provided to the charging port in response to deviation of the AC appliance voltage exceeding a corresponding threshold.

12. A coupling system comprising:
a vehicle cable having a plug configured to connect to a charging port of an electrified vehicle;
an electrical outlet configured to receive a plug of an AC-powered device, the electrical outlet electrically coupled to the vehicle cable to receive power from the electrified vehicle;
an energy store; and
a controller powered by the energy store, the controller configured to generate a signal on the vehicle cable to request the electrified vehicle to apply AC power to the charging port.

13. The coupling system of claim 12 further comprising a voltage converter coupled to the controller, the electrical outlet, the vehicle cable, and the energy store.

14. The coupling system of claim 13 wherein the controller is configured to control the voltage converter to charge the energy store using power supplied via the vehicle cable.

15. The coupling system of claim 13 wherein the controller is configured to control the voltage converter to transfer power between the energy store and the electrical outlet in response to variation of voltage at the electrical outlet exceeding an associated threshold.

16. The coupling system of claim 13 wherein the signal generated by the controller identifies the coupling system to the vehicle as a charging station.

17. The coupling system of claim 13 wherein the controller is configured to generate a signal on the vehicle capable to modify power supplied to the charging port in response to voltage at the electrical outlet being outside of a predetermined target range of a target voltage.

18. A coupling system comprising:
a housing;
a cable extending from the housing and having a plug configured to connect to a charging port of an electrified vehicle;
an electrical outlet secured to the housing and configured to receive a plug of an AC-powered device, the electrical outlet configured to receive power via the cable;
a rechargeable battery disposed within the housing;
a voltage converter disposed within the housing; and
a controller disposed within the housing and powered by the rechargeable battery, the controller configured to generate a first signal on the cable identifying the coupling system as a vehicle charging station, and a second signal on the cable requesting power to be supplied from the charging port, the controller further configured to control the voltage converter to control voltage provided to the electrical outlet from the cable.

19. The coupling system of claim 18 wherein the controller is further configured to supply power from the rechargeable battery to the electrical outlet via the voltage converter in response to electrical outlet voltage being outside a predetermined range of a target voltage.

20. The coupling system of claim 19 wherein the controller is further configured to control the voltage converter to charge the rechargeable battery.
